(19) United States
(12) Patent Application Publication
(10) Pub. No.: US 2023/0229169 A1
(43) Pub. Date: Jul. 20, 2023

(54) UNMANNED VEHICLE CONTROL SYSTEM, UNMANNED VEHICLE, AND UNMANNED VEHICLE CONTROL METHOD

(71) Applicant: Komatsu Ltd., Tokyo (JP)

(72) Inventors: Kenta Osagawa, Tokyo (JP); Isao Toku, Tokyo (JP)

(73) Assignee: Komatsu Ltd., Tokyo (JP)

(21) Appl. No.: 18/007,832

(22) PCT Filed: May 10, 2021
(86) PCT No.: PCT/JP2021/017713

§ 371 Date: Dec. 2, 2022

(30) Foreign Application Priority Data
Jun. 30, 2020 (JP) 2020-112596

(51) Int. Cl. G05D 1/02

(52) U.S. Cl. CPC G05D 1/0214; G05D 1/0291; G05D 1/0223; G05D 2201/021; G05D 2201/0202

(57) ABSTRACT

An unmanned vehicle control method for setting a permitted area where traveling is permitted for each unmanned vehicle, the unmanned vehicle control method includes: acquiring unmanned vehicle data including position data of the unmanned vehicle; acquiring road surface condition data of a travel path on which the unmanned vehicle travels; and generating data including a permitted area in the travel path of the unmanned vehicle, a stop point in the permitted area, and a target traveling speed for the unmanned vehicle to stop at the stop point on a basis of the unmanned vehicle data that has been acquired, wherein the permitted area is set on a basis of the road surface condition data of a predetermined area including the stop point.

### DESCRIPTION

### Field

The present disclosure relates to an unmanned vehicle control system, an unmanned vehicle, and an unmanned vehicle control method.

### Background

There are cases where unmanned vehicles that travel in an unmanned manner along a travel course are used in a wide-area work site such as a mine.

### CITATION LIST

### Patent Literature

Patent Literature 1: WO 2016/139757 A

### SUMMARY

### Technical Problem

In a work site, a plurality of unmanned vehicles is used. An unmanned vehicle is permitted to travel in a permitted area set ahead in a traveling direction. The traveling speed of the unmanned vehicle is controlled so that the unmanned vehicle stops by the end of the permitted area. However, if the unmanned vehicle slips, there is a possibility that the unmanned vehicle cannot stop by the end of the permitted area.

An object of an aspect of the present disclosure is to secure safety of a work site where an unmanned vehicle operates and to suppress a decrease in productivity.

### Solution to Problem

According to an aspect of the present invention, an unmanned vehicle control system for setting a permitted area where travelling is permitted for each unmanned vehicle, the unmanned vehicle control system comprises: an unmanned vehicle data acquisition unit that acquires unmanned vehicle data including position data of the unmanned vehicle; a road surface condition data acquisition unit that acquires road surface condition data that allows estimation of accuracy of stopping of a travel path on which the unmanned vehicle travels; and a traveling condition data generation unit that generates data including a permitted area in a travel path of the unmanned vehicle, a stop point in the permitted area, and a target traveling speed for the unmanned vehicle to stop at the stop point on a basis of the unmanned vehicle data acquired by the unmanned vehicle data acquisition unit, wherein the traveling condition data generation unit sets the permitted area or the stop point on a basis of the road surface condition data of a predetermined area including the stop point acquired by the road surface condition data acquisition unit.

### Advantageous Effects of Invention

According to an aspect of the present disclosure, it is possible to ensure safety of a work site where an unmanned vehicle operates and to suppress a decrease in productivity.

### BRIEF DESCRIPTION OF DRAWINGS

FIG. 1 is a diagram schematically illustrating an example of a control system and an unmanned vehicle according to an embodiment.

FIG. 2 is a diagram schematically illustrating an unmanned vehicle and a travel path according to the embodiment.

FIG. 3 is a functional block diagram illustrating an unmanned vehicle control system of according to the embodiment.

FIG. 4 is a diagram schematically illustrating an example of a permitted area.

FIG. 5 is a diagram schematically illustrating another example of the permitted area.

FIG. 6 is a flowchart illustrating an unmanned vehicle control method according to the embodiment.

FIG. 7 is a diagram schematically illustrating an example of settings of the permitted area.

FIG. 8 is a schematic diagram illustrating an example of a speed limit of the unmanned vehicle.

FIG. 9 is a schematic diagram illustrating another example of the speed limit of the unmanned vehicle.

FIG. 10 is a block diagram illustrating an example of a computer system according to the embodiment.

### DESCRIPTION OF EMBODIMENTS

Hereinafter, embodiments of the present disclosure will be described with reference to the drawings; however, the present disclosure is not limited thereto. Components of the embodiments described below can be combined as appropriate. Moreover, some of the components may not be used.

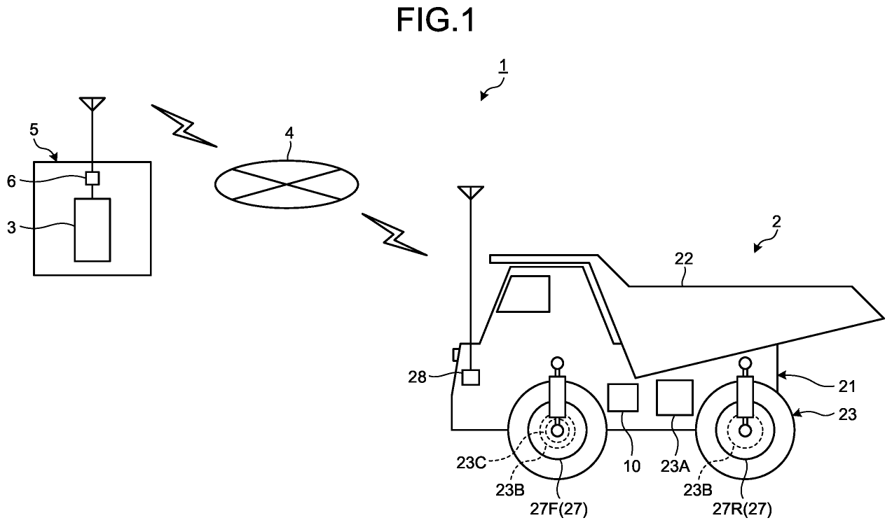

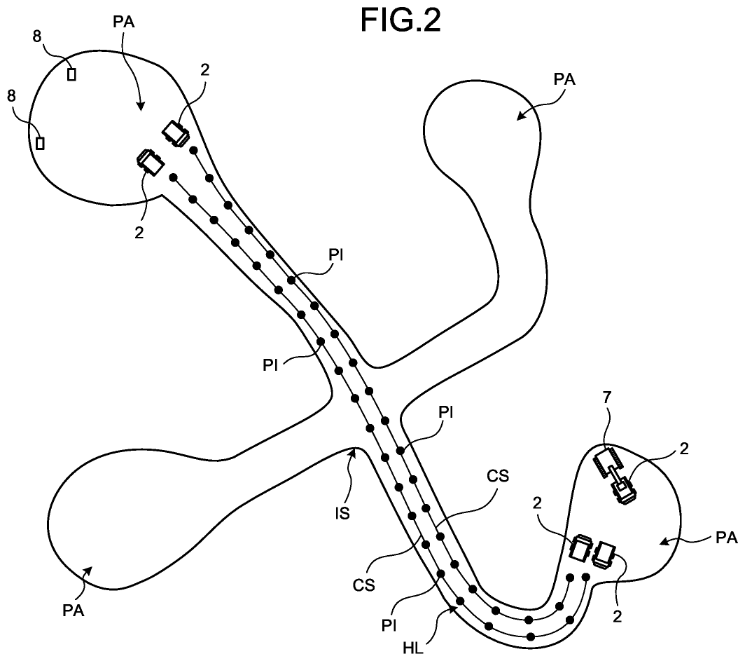

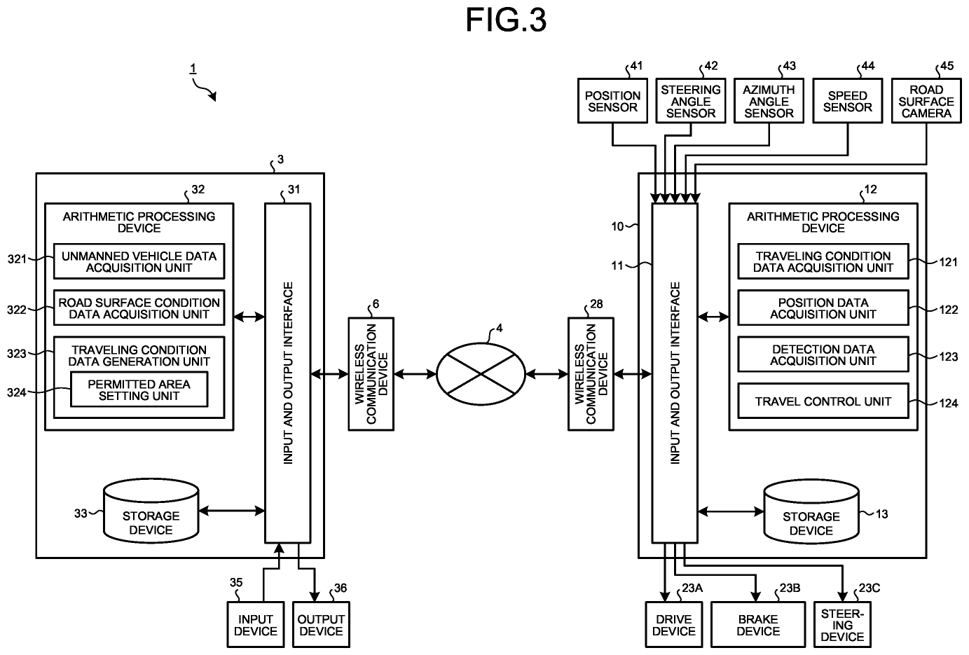

FIG. 1 is a diagram schematically illustrating an example of a control system 1 and an unmanned vehicle 2 according to the present embodiment. FIG. 2 is a diagram schematically illustrating the unmanned vehicles 2 and a travel path HL according to the embodiment. FIG. 3 is a functional block diagram illustrating the control system 1 of the unmanned vehicle 2 according to the embodiment. In the present embodiment, the unmanned vehicles 2 are used at a work site. The unmanned vehicle 2 refers to a work vehicle that travels in an unmanned manner in accordance with a control command without depending on a driving operation by a driver.

The work site is, for example, a mine. The mine refers to a place or a business site where minerals are mined. The load carried by the unmanned vehicle 2 is, for example, ore or earth and sand excavated in a mine. The unmanned vehicles 2 travel at least a part of a travel path HL leading to a plurality of work areas PA in the mine. The work area PA includes at least one of a loading station or a soil discharging site. The travel path HL includes an intersection IS. The loading place refers to an area in which loading work for loading a load on an unmanned vehicle 2 is performed. In the loading station, a loader 7 such as a hydraulic shovel operates. The soil discharging site refers to an area where discharging work for discharging a load from an unmanned vehicle 2 is performed. For example, crushers 8 are installed in the soil discharging site.

The unmanned vehicles 2 are, for example, dump trucks that travel at the work site and transport a load.

The control system 1 is a control system of the unmanned vehicle 2 that sets a permitted area AP that permits traveling for each of the unmanned vehicles 2 or a stop point SP. The control system 1 includes a management device 3 and a communication system 4. The management device 3 includes a computer system and is installed in a control facility 5 at a work site. An operator is present in the control facility 5. The communication system 4 performs communication between the management device 3 and the unmanned vehicle 2. A wireless communication device 6 is connected to the management device 3. The communication system 4 includes the wireless communication device 6. The management device 3 and the unmanned vehicle 2 wirelessly communicate with each other via the communication system 4. The unmanned vehicles 2 each output unmanned vehicle data thereof to the management device 3. The unmanned vehicle 2 travels on the travel path HL at the work site on the basis of traveling condition data transmitted from the management device 3. The unmanned vehicle 2 travels along a travel course CS set in the travel path HL and the work area PA on the basis of a control signal from the management device 3.

### Unmanned Vehicle

An unmanned vehicle 2 includes a vehicle body 21, a dump body 22 supported by the vehicle body 21, a traveling device 23 supporting the vehicle body 21, a wireless communication device 28, a position sensor 41, a steering angle sensor 42, an azimuth angle sensor 43, a speed sensor 44, a road surface camera 45, and a control device 10. The control device 10 will be described later.

The vehicle body 21 includes a vehicle body frame and supports the dump body 22. The vehicle body 21 also includes a hydraulic pump (not illustrated) and a plurality of hydraulic cylinders (not illustrated) that operate with hydraulic oil discharged from the hydraulic pump.

The dump body 22 is a member on which a load is loaded. The dump body 22 ascends and descends by the operation of a hoist cylinder which is a hydraulic cylinder. The dump body 22 is adjusted to at least one of a loading attitude and a dump attitude by the operation of the hoist cylinder. The loading attitude is an attitude in which a load can be loaded and is an attitude in which the dump body 22 has descended. The dump attitude is an attitude in which the load is discharged and is an attitude in which the dump body 22 has ascended.

The traveling device 23 includes wheels 27 and travels on the travel path HL. The wheels 27 include front wheels 27F and rear wheels 27R. A tire is mounted on a wheel 27. The traveling device 23 includes a drive device 23A, brake devices 23B, and steering devices 23C.

The drive device 23A generates a driving force for accelerating the unmanned vehicle 2. The drive device 23A includes an internal combustion engine such as a diesel engine. Note that the drive device 23A may include an electric motor. The driving force generated by the drive device 23A is transmitted to the rear wheels 27R, and the rear wheels 27R rotate. When the rear wheels 27R rotate, the unmanned vehicle 2 is self-propelled.

The brake devices 23B generate a braking force for decelerating or stopping the unmanned vehicle 2.

The steering devices 23C can adjust the traveling direction of the unmanned vehicle 2. The traveling direction of the unmanned vehicle 2 includes the orientation of the front portion of the vehicle body 21. The steering devices 23C adjust the traveling direction of the unmanned vehicle 2 through steering of the front wheels 27F. A steering device 23C includes a steering cylinder which is a hydraulic cylinder. The front wheels 27F are steered by the power generated by the steering cylinder.

The wireless communication device 28 wirelessly communicates with the wireless communication device 6 connected to the management device 3. The communication system 4 includes the wireless communication device 28.

The position sensor 41 detects the position of the unmanned vehicle 2 traveling on the travel path HL. Detection data of the position sensor 41 includes absolute position data indicating the absolute position of the unmanned vehicle 2. The absolute position of the unmanned vehicle 2 is detected using a global navigation satellite system (GNSS). The global navigation satellite system includes the global positioning system (GPS). The position sensor 41 includes a GNSS receiver. The global navigation satellite system detects the absolute position of the unmanned vehicle 2 defined by coordinate data of longitude, latitude, and altitude. The global navigation satellite system detects the absolute position of the unmanned vehicle 2 defined in the global coordinate system. The global coordinate system refers to a coordinate system fixed to the earth.

The steering angle sensor 42 detects a steering angle of the unmanned vehicle 2 by the steering devices 23C. The steering angle sensor 42 includes, for example, a rotary encoder included in the steering devices 23C. The detection data of the steering angle sensor 42 includes steering angle data indicating a steering angle of the unmanned vehicle 2.

The azimuth angle sensor 43 detects an azimuth angle of the unmanned vehicle 2. The azimuth angle of the unmanned vehicle 2 includes a yaw angle of the unmanned vehicle 2. The yaw angle refers to an inclination angle of the unmanned vehicle 2 about a rotation axis extending in the vertical direction of the unmanned vehicle 2. Detection data of the azimuth angle sensor 43 includes azimuth angle data indicating an azimuth angle of the unmanned vehicle 2. The azimuth of the unmanned vehicle 2 is the traveling direction of the unmanned vehicle 2. The azimuth angle sensor 43 includes, for example, a gyro sensor.

The speed sensor 44 detects the traveling speed of the unmanned vehicle 2. Detection data of the speed sensor 44 includes traveling speed data indicating the traveling speed of the traveling device 23.

The road surface camera 45 photographs a road surface of the travel path HL ahead in the traveling direction ahead of the unmanned vehicle 2. The road surface camera 45 may be included in the unmanned vehicle 2.

Data detected by the position sensor 41, the steering angle sensor 42, the azimuth angle sensor 43, and the speed sensor 44 of the unmanned vehicle 2 and image data captured by the road surface camera 45 are output to the management device 3 as the unmanned vehicle data of the unmanned vehicle 2.

### Control System

As illustrated in FIG. 3, the control system 1 includes the management device 3 and the control device 10. The control system 1 controls the unmanned vehicle 2 at the work site. The control device 10 can communicate with the management device 3 via the communication system 4.

### Management Device

The management device 3 sets a traveling condition of the unmanned vehicle 2 on the travel path HL. The unmanned vehicle 2 travels on the travel path HL on the basis of traveling condition data defining the traveling condition transmitted from the management device 3.

The management device 3 includes a computer system. The management device 3 includes an input and output interface 31, an arithmetic processing device 32 including a processor such as a central processing unit (CPU), and a storage device 33 including a memory such as a read only memory (ROM) or a random access memory (RAM) and a storage.

The input and output interface 31 is connected to each of an input device 35, an output device 36, and the wireless communication device 6. Each of the input device 35, the output device 36, and the wireless communication device 6 is installed in the control facility 5. The input and output interface 31 transmits the traveling condition data to the unmanned vehicle 2 via the communication system 4. The input and output interface 31 receives the unmanned vehicle data from the unmanned vehicle 2 via the communication system 4.

The arithmetic processing device 32 includes an unmanned vehicle data acquisition unit 321, a road surface condition data acquisition unit 322, a traveling condition data generation unit 323, and a permitted area setting unit 324.

The unmanned vehicle data acquisition unit 321 acquires unmanned vehicle data including position data of the unmanned vehicle 2 at the work site. The unmanned vehicle data acquisition unit 321 acquires the unmanned vehicle data of the unmanned vehicle 2 transmitted from the control device 10 via the input and output interface 31. The unmanned vehicle data refers to data indicating the operation state of the unmanned vehicle 2. The data of the unmanned vehicle 2 includes detection data of the sensors mounted on the unmanned vehicle 2.

The road surface condition data acquisition unit 322 acquires road surface condition data indicating a road surface condition in which the accuracy of stopping on the travel path HL on which the unmanned vehicle 2 travels at the work site can be estimated. The road surface condition data acquisition unit 322 acquires the road surface condition data indicating the road surface condition of the travel path HL that has been input via the input and output interface 31. The road surface condition data includes data related to the moisture content of a road surface. The data related to the moisture content includes, for example, data of slippery spots such as a puddle or a muddy spot on a road surface. More specifically, the road surface condition data may include data of a spot set by the operator, for example, position data of a spot where it is determined by the operator that a slip may occur. In addition, the road surface condition data may include at least one of sprinkled water data including the amount of sprinkled water sprinkled onto a road surface by a sprinkler vehicle, image data of the road surface of the travel path HL captured by the road surface camera 45 mounted on the unmanned vehicle 2, or traveling data of another unmanned vehicle 2. It is possible to recognize a puddle or a mud on the road surface by performing image processing on the image data. In a case where the travel data of the other unmanned vehicle 2 indicates that the other unmanned vehicle 2 has slipped, it can be recognized as a spot where a slip is likely to occur.

The traveling condition data generation unit 323 generates traveling condition data that defines the traveling conditions of the unmanned vehicle 2. More specifically, based on the unmanned vehicle data acquired by the unmanned vehicle data acquisition unit 321, the traveling condition data generation unit 323 generates the traveling condition data including the permitted area AP in the travel path HL of the unmanned vehicle 2, the stop point SP in the permitted area AP, and a target traveling speed for the unmanned vehicle 2 to stop at the stop point SP. The traveling condition data generation unit 323 has a function of setting the permitted area AP or the stop point SP on the basis of the road surface condition data of a predetermined area including the stop point SP that has been acquired by the road surface condition data acquisition unit 322. The area including the stop point SP is an area around the stop point SP in the permitted area AP. The traveling condition data generation unit 323 communicates with each of the input device 35, the output device 36, and the wireless communication device 6 via the input and output interface 31.

The traveling condition is determined, for example, by an operator present in the control facility 5. The operator operates the input device 35 connected to the management device 3. The traveling condition data is generated on the basis of input data generated by operation of the input device 35.

The traveling condition data includes a target position, a target traveling speed, a target azimuth, and the travel course CS of the unmanned vehicle 2. The traveling condition data further includes permitted area data of the permitted area AP set by the permitted area setting unit 324 to be described later.

As illustrated in FIG. 2, the traveling condition data includes a plurality of target points PI set at intervals on the travel path HL. An interval between target points PI is set to, for example, a range between 1 [m] and 5 [m]. A target point PI defines a target position of the unmanned vehicle 2. The target traveling speed and the target azimuth are set at each of the plurality of target points PI. The travel course CS is defined by a line connecting the plurality of target points PI. That is, the traveling condition data defining the traveling condition of the unmanned vehicle 2 includes the plurality of target points PI indicating target positions of the unmanned vehicle 2 and the target traveling speed and the target azimuth of the unmanned vehicle 2 set at each of the plurality of target points PI.

A target position of the unmanned vehicle 2 refers to a target position of the unmanned vehicle 2 defined in the global coordinate system. That is, a target position refers to a target position in coordinate data defined by longitude, latitude, and altitude. A target position includes a target position in longitude (x coordinate) and a target position in latitude (y coordinate). Note that a target position of the unmanned vehicle 2 may be defined in a local coordinate system of the unmanned vehicle 2.

The target traveling speed of the unmanned vehicle 2 refers to a target traveling speed of the unmanned vehicle 2 when traveling (passing) through the target point PI. For example, in a case where a target traveling speed at a target point PI is set, the drive device 23A or the brake devices 23B of the unmanned vehicle 2 is controlled so that the actual traveling speed of the unmanned vehicle 2 when traveling through the target point PI is the target traveling speed.

The target azimuth of the unmanned vehicle 2 refers to a target azimuth of the unmanned vehicle 2 when traveling (passing) through the target point PI. Meanwhile, a target azimuth refers to an azimuth angle of the unmanned vehicle 2 with respect to a reference azimuth (for example, north). In other words, a target azimuth is a target azimuth of the front portion of the vehicle body 21 and indicates a target traveling direction of the unmanned vehicle 2. For example, in a case where a target azimuth at a target point PI is set, the steering devices 23C of the unmanned vehicle 2 are controlled so that the actual azimuth of the unmanned vehicle 2 when traveling through the target point PI is the target azimuth.

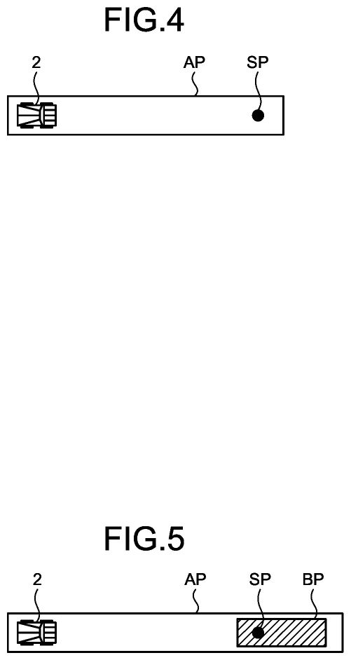

The permitted area setting unit 324 will be described with reference to FIGS. 4 and 5. FIG. 4 is a diagram schematically illustrating an example of the permitted area AP. FIG. 5 is a diagram schematically illustrating another example of the permitted area AP. The permitted area setting unit 324 is one of the functions of the traveling condition data generation unit 323. As one of the functions of the traveling condition data generation unit 323, the permitted area setting unit 324 sets the permitted area AP or the stop point SP depending on the road surface condition data of the predetermined area including the stop point SP that has been acquired by the road surface condition data acquisition unit 322. As one of the functions of the traveling condition data generation unit 323, the permitted area setting unit 324 may extend the permitted area AP ahead of the stop point SP in the traveling direction depending on the slip amount estimated in the predetermined area including the stop point SP. As one of the functions of the traveling condition data generation unit 323, the permitted area setting unit 324 may set the stop point SP to a position shifted toward the rear end of the permitted area AP without changing the permitted area AP depending on the slip amount estimated in the predetermined area including the stop point SP.

As illustrated in FIG. 4, the permitted area setting unit 324 sets the permitted area AP in which the unmanned vehicle 2 is permitted to travel. The permitted area AP is an area where entry of other unmanned vehicles 2 is prohibited. Permitted areas AP of a plurality of unmanned vehicles 2 are set so as not to overlap each other. The permitted area AP is formed in a belt shape ahead in the traveling direction of the unmanned vehicle 2, for example, in correspondence with the travel course CS. The permitted area AP has a length of, for example, about several hundred meters in the traveling direction of the unmanned vehicle 2. The traveling speed of the unmanned vehicle 2 is controlled so that the unmanned vehicle 2 can be stopped at the stop point SP provided at the end of the permitted area AP. As the unmanned vehicle 2 travels, the permitted area setting unit 324 releases the permitted area AP that has passed and extends the permitted area AP ahead in the traveling direction. As the permitted area AP extends with the traveling of the unmanned vehicle 2, the unmanned vehicle 2 can continuously travel without stopping. In a case where the permitted area AP cannot be extended ahead in the traveling direction since another unmanned vehicle 2 is stopped or the like, the unmanned vehicle 2 travels to the stop point SP and stops. The permitted area data of the permitted area AP set by the permitted area setting unit 324 is included in the traveling condition data.

As illustrated in FIG. 5, the permitted area setting unit 324 sets an additional permitted area BP ahead of the permitted area AP depending on the accuracy of stopping of the unmanned vehicle 2 in the predetermined area including the stop point SP. More specifically, in a case where the predetermined area including the stop point SP is in a road surface condition in which the unmanned vehicle 2 may easily slip, in other words, in a case where it is estimated that the accuracy of stopping in the predetermined area including the stop point SP is poor, the permitted area setting unit 324 sets the additional permitted area BP ahead of the permitted area AP and extends the permitted area AP ahead.

It can be determined from the road surface condition data acquired by the road surface condition data acquisition unit 322 whether or not the road surface condition is likely to cause a slip. For example, in a case where position data of a predetermined area including the stop point SP, which is determined by the operator to have a possibility of occurrence of a slip, is acquired as the road surface condition data, it is determined that the road surface condition is likely to cause a slip. For example, in a case where sprinkled water data including the amount of sprinkled water sprinkled on the road surface in the predetermined area including the stop point SP by a sprinkler vehicle has been acquired as the road surface condition data, it is determined that the road surface condition is likely to cause a slip. For example, in a case where a puddle, a mud, or the like on the road surface is recognized by performing image processing on the image data of the road surface in the predetermined area including the stop point SP as the road surface condition data, it is determined that the road surface condition is likely to cause a slip. For example, in a case where travel data of another unmanned vehicle 2 indicates that the other unmanned vehicle 2 has slipped in the predetermined area including the stop point SP as the road surface condition data, it is determined that the road surface condition is likely to cause a slip.

The additional permitted area BP has a length that allows the unmanned vehicle 2 to stop in a case of a slip. The slip amount of the unmanned vehicle 2 in the predetermined area including the stop point SP is estimated, and the additional permitted area BP is set to have a length that corresponds to the slip amount that has been estimated. The slip amount may be estimated, for example, by an operator. A relational expression or a map of the slip amount with respect to a predetermined parameter such as unmanned vehicle data or road surface condition data is stored in a memory, and the slip amount may be calculated using the relational expression or the map. The slip amount may be estimated from, for example, the amount of sprinkled water. The slip amount may be estimated, for example, from the size of the puddle or the mud recognized from the image data. The slip amount may be estimated, for example, from the travel data of the other unmanned vehicle 2. In a case where the additional permitted area BP having a length corresponding to the slip amount cannot be secured, the permitted area setting unit 324 shifts the stop point SP closer, in other words, toward the rear end of the permitted area AP by a length corresponding to the slip amount.

The storage device 33 stores the road surface condition data input via the input device 35. The storage device 33 stores the unmanned vehicle data acquired from the unmanned vehicle 2.

The input device 35 generates input data by being operated by the operator of the control facility 5. The input data generated by the input device 35 is output to the management device 3. The management device 3 acquires the input data from the input device 35. Examples of the input device 35 include a contact-type input device operated by a hand of the operator, such as a computer keyboard, a mouse, a touch panel, an operation switch, and an operation button. Note that the input device 35 may be a speech input device operated by speech of the operator.

The output device 36 provides output data to the operator of the control facility 5. The output device 36 may be a display device that outputs display data, a printing device that outputs print data, or an audio output device that outputs audio data. Examples of the display device includes a flat panel display such as a liquid crystal display (LCD) or an organic electroluminescence display (OELD).

### Control Device

The control device 10 includes a computer system and is disposed in the vehicle body 21. The control device 10 outputs a control command for controlling traveling of the traveling device 23 of the unmanned vehicle 2. The control command output from the control device 10 includes an acceleration command for operating the drive device 23A, a brake command for operating the brake devices 23B, and a steering command for operating the steering devices 23C. The drive device 23A generates a driving force for accelerating the unmanned vehicle 2 on the basis of the acceleration command output from the control device 10. The brake devices 23B generate a braking force for decelerating or stopping the unmanned vehicle 2 on the basis of the brake command output from the control device 10. The steering devices 23C generate a turning force for changing the direction of the front wheels 27F in order to cause the unmanned vehicle 2 to travel straight or turn on the basis of the steering command output from the control device 10.

The control device 10 includes an input and output interface 11, an arithmetic processing device 12 including a processor such as a CPU, and a storage device 13 including a memory such as a ROM or a RAM and a storage. The control device 10 acquires the traveling condition data transmitted from the management device 3 via the communication system 4.

The input and output interface 11 is connected to each of the position sensor 41, the steering angle sensor 42, the azimuth angle sensor 43, the speed sensor 44, the road surface camera 45, the traveling device 23, and the wireless communication device 28. The input and output interface 11 communicates with each of the position sensor 41, the steering angle sensor 42, the azimuth angle sensor 43, the speed sensor 44, the road surface camera 45, the traveling device 23, and the wireless communication device 28.

The arithmetic processing device 12 includes a traveling condition data acquisition unit 121, a position data acquisition unit 122, a detection data acquisition unit 123, and a travel control unit 124.

The traveling condition data acquisition unit 121 acquires the traveling condition data generated by the traveling condition data generation unit 323 of the management device 3. The traveling condition data acquisition unit 121 acquires updated traveling condition data each time the traveling condition data is updated by the management device 3. More specifically, every time the permitted area AP is updated by the management device 3, the traveling condition data acquisition unit 121 acquires the traveling condition data including the updated permitted area data. For example, as the unmanned vehicle 2 travels, the traveling condition data acquisition unit 121 acquires traveling condition data including the permitted area data in which the permitted area AP that has been passed is released and the permitted area AP is extended ahead in the traveling direction.

The position data acquisition unit 122 acquires position data indicating the position of the unmanned vehicle 2 from the position sensor 41.

The detection data acquisition unit 123 acquires detection data of the azimuth angle sensor 43 that has detected the traveling direction of the unmanned vehicle 2 from the azimuth angle sensor 43. The detection data includes steering angle data detected by the steering angle sensor 42, azimuth angle data detected by the azimuth angle sensor 43, and speed data detected by the speed sensor 44. The detection data acquisition unit 123 acquires steering angle data from the steering angle sensor 42, azimuth angle data from the azimuth angle sensor 43, and speed data from the speed sensor 44. The detection data acquisition unit 123 acquires the image data captured by the road surface camera 45 from the road surface camera 45.

The travel control unit 124 outputs a control signal for controlling at least one of the drive device 23A, the brake devices 23B, or the steering devices 23C of the unmanned vehicle 2 on the basis of the travel course CS acquired by the traveling condition data acquisition unit 121. The management device 3 outputs the travel course CS generated by the traveling condition data generation unit 323 from the input and output interface 11 to the travel control unit 124 of the unmanned vehicle 2. The travel course CS generated by the traveling condition data generation unit 323 is transmitted from the input and output interface 11 to the travel control unit 124 of the unmanned vehicle 2.

The travel control unit 124 generates a control signal for controlling the travel of the unmanned vehicle 2 on the basis of the travel course CS. The control signal generated by the travel control unit 124 is output from the travel control unit 124 to the traveling device 23. The control signal output from the travel control unit 124 includes an acceleration signal output to the drive device 23A, a brake control signal output to the brake devices 23B, and a steering control signal output to the steering devices 23C. On the basis of the position data detected by the position sensor 41, the travel control unit 124 controls the drive device 23A, the brake devices 23B, and the steering devices 23C so that a state where a specific part of the unmanned vehicle 2 and the travel course CS coincide with each other during the travel.

The travel control unit 124 controls the traveling of the unmanned vehicle 2 on the basis of the traveling condition data. The travel control unit 124 outputs an acceleration command value corresponding to the traveling speed to the drive device 23A of the traveling device 23. The drive device 23A generates power on the basis of the acceleration command value. In a case where speed condition data includes a speed limit, the travel control unit 124 outputs an acceleration command value or a brake command value so as to decelerate the traveling speed.

The travel control unit 124 controls the travel of the unmanned vehicle 2 in the permitted area AP on the basis of the permitted area data set by the permitted area setting unit 324. The travel control unit 124 controls the traveling speed of the unmanned vehicle 2 so that the unmanned vehicle 2 can stop at the stop point SP in the permitted area AP. In a case where the permitted area AP is not extended ahead in the traveling direction when the unmanned vehicle 2 is travelling and the permitted area data included in the traveling condition data is not updated, the travel control unit 124 causes the unmanned vehicle 2 to travel to the stop point SP and to stop. In a case where the permitted area AP is extended ahead in the traveling direction and the permitted area data included in the traveling condition data is updated when the unmanned vehicle 2 is traveling, the travel control unit 124 causes the unmanned vehicle 2 to continue traveling.

### Control Method

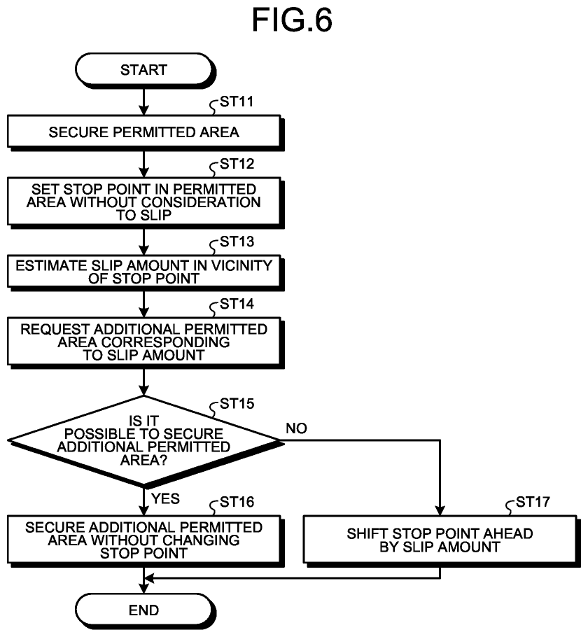

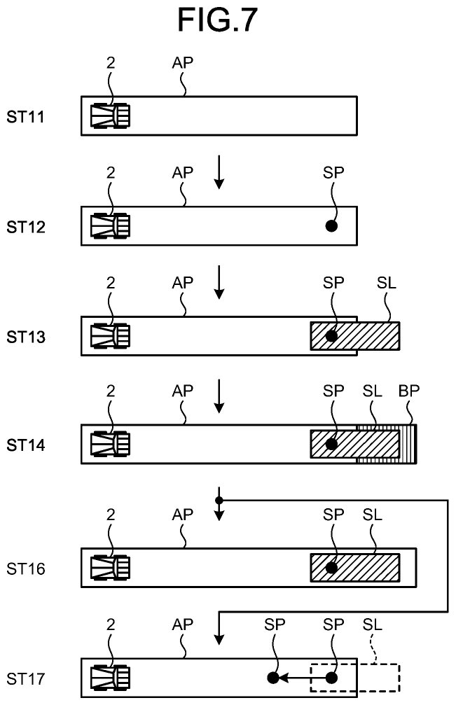

FIG. 6 is a flowchart illustrating a control method of the unmanned vehicle 2 according to the present embodiment. FIG. 7 is a diagram schematically illustrating an example of settings of the permitted area AP. During the operation of the control system 1, the arithmetic processing device 32 of the management device 3 acquires, by the unmanned vehicle data acquisition unit 321, the unmanned vehicle data transmitted from the control device 10 of the unmanned vehicle 2 at the work site via the input and output interface 31. The arithmetic processing device 32 of the management device 3 acquires the road surface condition data by the road surface condition data acquisition unit 322. In addition, the arithmetic processing device 32 of the management device 3 generates, by the traveling condition data generation unit 323, the traveling condition data defining the traveling condition of the unmanned vehicle 2. The processing of the flowchart illustrated in FIG. 6 is executed for every unmanned vehicle 2.

The arithmetic processing device 32 of the management device 3 secures a permitted area AP for every unmanned vehicle 2 (step ST11). More specifically, the permitted area setting unit 324 sets the permitted area AP in which the unmanned vehicle 2 is permitted to travel. As illustrated in FIG. 7, the permitted area AP is set ahead in the traveling direction of the unmanned vehicle 2.

The arithmetic processing device 32 of the management device 3 sets a stop point SP in the permitted area AP of the unmanned vehicle 2 without considering a slip (step ST12). More specifically, the permitted area setting unit 324 sets the stop point SP at the front end of the permitted area AP of the unmanned vehicle 2. As illustrated in FIG. 7, the stop point SP is set at the front end of the permitted area AP of the unmanned vehicle 2.

The arithmetic processing device 32 of the management device 3 estimates a slip amount SL in a predetermined area including the stop point SP, which is an area around the stop point SP (step ST13). More specifically, the permitted area setting unit 324 estimates the slip amount SL in the predetermined area including the stop point SP of the unmanned vehicle 2 on the basis of the road surface condition data. In a case where it is determined by the permitted area setting unit 324 that the predetermined area including the stop point SP of the unmanned vehicle 2 is likely to cause a slip on the basis of the road surface condition data acquired by the road surface condition data acquisition unit 322, the slip amount SL is calculated, and in a case where it is not determined that the predetermined area including the stop point SP of the unmanned vehicle 2 is likely to cause a slip, the slip amount SL is set to zero. In the example illustrated in FIG. 7, the slip amount SL of the predetermined area including the estimated stop point SP deviates ahead of the permitted area AP of the unmanned vehicle 2. In this state, in a case where the unmanned vehicle 2 slips in the predetermined area including the stop point SP, there is a high possibility that the unmanned vehicle 2 cannot stop within the permitted area AP.

The arithmetic processing device 32 of the management device 3 requests to secure an additional permitted area BP corresponding to the slip amount SL (step ST14). More specifically, the permitted area setting unit 324 requests to secure the additional permitted area BP ahead of the permitted area AP. As illustrated in FIG. 7, the additional permitted area BP requests to secure the additional permitted area BP corresponding to the slip amount SL ahead in the traveling direction of the unmanned vehicle 2. The additional permitted area BP is set so as to include the slip amount SL.

The arithmetic processing device 32 of the management device 3 determines whether the additional permitted area BP has been secured (step ST15). More specifically, for example, in a case where there is no other vehicle or the like ahead of the permitted area AP of the unmanned vehicle 2, the additional permitted area BP can be secured. For example, in a case where there is an obstacle such as another unmanned vehicle 2 ahead of the permitted area AP of the unmanned vehicle 2, the additional permitted area BP cannot be secured. If it is determined that the additional permitted area BP has been secured by the permitted area setting unit 324 (Yes in step ST15), the process proceeds to step ST16. If it is not determined that the additional permitted area BP has been secured by the permitted area setting unit 324 (No in step ST15), the process proceeds to step ST17.

If it is determined that the additional permitted area BP has been secured (Yes in step ST15), the additional permitted area BP is secured while the stop point SP is kept as it is, and the permitted area AP is extended (step ST16). As illustrated in FIG. 7, the additional permitted area BP secures an area corresponding to the slip amount SL ahead in the traveling direction of the unmanned vehicle 2. The permitted area AP is extended ahead in the traveling direction of the unmanned vehicle 2.

If it is not determined that the additional permitted area BP has been secured (No in step ST15), the stop point SP is shifted ahead by the slip amount SL (step ST17). As illustrated in FIG. 7, the stop point SP is shifted ahead while the permitted area AP is kept as it is.

The management device 3 transmits the traveling condition data including the permitted area data of the permitted area AP set in this manner to the control device 10 of the unmanned vehicle 2 via the input and output interface 31.

In the unmanned vehicle 2, a control signal is output to the traveling device 23 so that the unmanned vehicle 2 travels in the permitted area AP on the basis of the traveling condition data acquired from the management device 3 via the input and output interface 11.

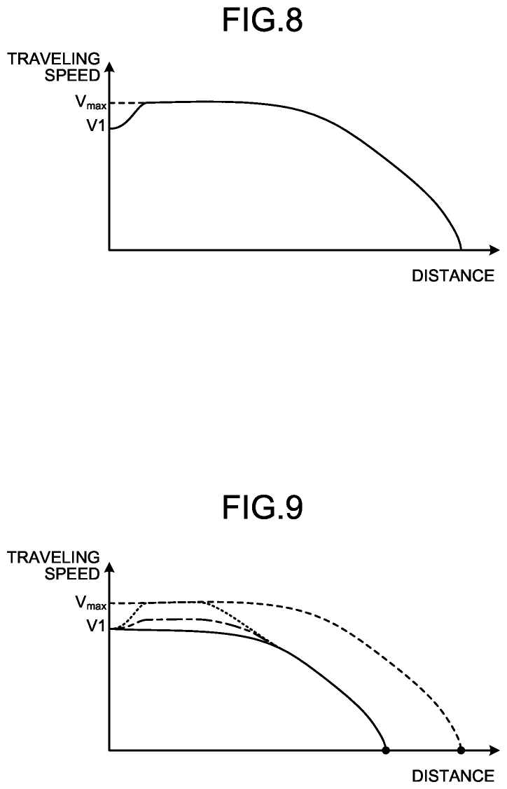

The control of the traveling speed in the permitted area AP will be described with reference to FIGS. 8 and 9. FIG. 8 is a schematic diagram illustrating an example of the speed limit of the unmanned vehicle 2. FIG. 9 is a schematic diagram illustrating another example of the speed limit of the unmanned vehicle 2. As illustrated in FIG. 8, let us presume that the speed limit of the permitted area AP is Vmax. In this case, a control signal is output so that the unmanned vehicle 2 at a current traveling speed of V1 (V1<Vmax) in the permitted area AP accelerates to Vmax. Then, when a position behind the stop point SP by a predetermined distance is reached, a control signal is output to decelerate so that the traveling speed becomes zero at the position of the stop point SP. In a case where the permitted area AP is updated and extended before arrival at the position behind the stop point SP by a predetermined distance, the traveling at a constant speed is continued without being decelerated. If the permitted area AP is extended as in step ST16, even if the unmanned vehicle 2 slips in a predetermined area including the stop point SP and cannot stop at the stop point SP, the unmanned vehicle 2 is suppressed from deviating from the permitted area AP.

In FIG. 9, illustrated is the speed limit in a case where the stop point SP is shifted behind by the slip amount SL as in step ST17. In this case, when a position behind the stop point SP by a predetermined distance is reached, a control signal is output to decelerate so that the traveling speed becomes zero at the position of the stop point SP shifted behind. If the stop point SP is shifted behind, even if the unmanned vehicle 2 slips in the predetermined area including the stop point SP and cannot stop at the stop point SP, the unmanned vehicle 2 is suppressed from deviating from the permitted area AP.

### Computer System

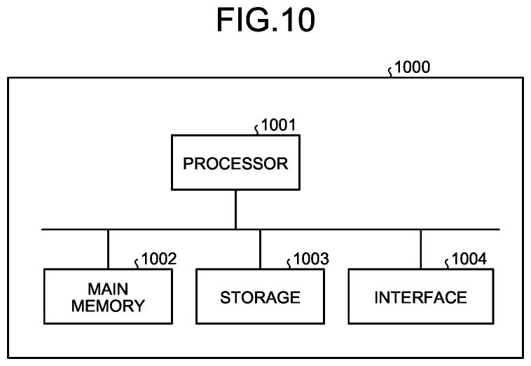

FIG. 10 is a block diagram illustrating an example of a computer system 1000. Each of the management device 3 and the control device 10 described above includes the computer system 1000. The computer system 1000 includes a processor 1001 such as a CPU, a main memory 1002 including a nonvolatile memory such as a ROM and a volatile memory such as a RAM, a storage 1003, and an interface 1004 including an input and output circuit. The functions of the management device 3 and the functions of the control device 10 are stored in the storage 1003 as a program. The processor 1001 reads the program from the storage 1003, loads the program in the main memory 1002, and executes the above-described processing in accordance with the program. Note that the program may be distributed to the computer system 1000 via a network.

### Effects

As described above, in the present embodiment, the permitted area AP can be appropriately set on the basis of the road surface condition data of the predetermined area including the stop point SP of the permitted area AP of the unmanned vehicle 2. According to the present embodiment, in a case where the road surface condition changes, a permitted area AP or a stop point SP can be set according to the change. According to the present embodiment, it is possible to secure the safety of a work site where the unmanned vehicle 2 operates and to suppress a decrease in the productivity.

In the present embodiment, the permitted area AP is extended ahead in the traveling direction from the stop point SP depending on the slip amount estimated in the predetermined area including the stop point SP of the permitted area AP of the unmanned vehicle 2. According to the present embodiment, even in a case where the unmanned vehicle 2 slips in the predetermined area including the stop point SP, the permitted area AP can be set so that the unmanned vehicle 2 stops in the permitted area AP. According to the present embodiment, since the unmanned vehicle 2, which has slipped, is suppressed from deviating from the permitted area AP, the safety of vehicles around the unmanned vehicle 2 can also be secured.

In the present embodiment, the stop point SP in the permitted area AP is set depending on the slip amount estimated in a predetermined area including the stop point SP in the permitted area AP of the unmanned vehicle 2. According to the present embodiment, even in a case where the unmanned vehicle 2 slips in a predetermined area including the stop point SP, the permitted area AP, in which the stop point SP is shifted, can be set so that the unmanned vehicle 2 stops in the permitted area AP. According to the present embodiment, since the unmanned vehicle 2, which has slipped, is suppressed from deviating from the permitted area AP, the safety of vehicles around the unmanned vehicle 2 can also be secured.

In the present embodiment, the road surface condition data includes data of a slippery spot such as a puddle or a muddy spot on a road surface. In the present embodiment, the accuracy of stopping in a predetermined area including the stop point SP of the permitted area AP of the unmanned vehicle 2 can be appropriately estimated.

The present embodiment includes position data of a spot where it has been determined by the operator that a slip may occur. In the present embodiment, the accuracy of stopping in a predetermined area including the stop point SP of the permitted area AP of the unmanned vehicle 2 can be appropriately estimated.

In the present embodiment, the road surface condition data includes sprinkled water data including the amount of sprinkled water sprinkled on a road surface by a sprinkler vehicle. In the present embodiment, the accuracy of stopping in a predetermined area including the stop point SP of the permitted area AP of the unmanned vehicle 2 can be appropriately estimated from the sprinkled water data.

In the present embodiment, the road surface condition data includes image data of a road surface captured by a camera that captures the road surface of the travel path HL. In the present embodiment, the accuracy of stopping in a predetermined area including the stop point SP of the permitted area AP of the unmanned vehicle 2 can be appropriately estimated from the image data of the road surface.

In the present embodiment, road surface condition data includes travel data of another unmanned vehicle 2. In the present embodiment, the accuracy of stopping in the predetermined area including the stop point SP of the permitted area AP of the unmanned vehicle 2 can be appropriately estimated from the travel data of another unmanned vehicle 2.

### Other Embodiments

In the above-described embodiment, at least some of the functions of the control device 10 may be included in the management device 3, and at least some of the functions of the management device 3 may be included in the control device 10. For example, in the above-described embodiment, the control device 10 of the unmanned vehicle 2 may have the function of the traveling condition data generation unit 323 of the management device 3. The travel control unit 124 of the control device 10 controls the unmanned vehicle 2 on the basis of traveling condition data that has been generated.

### Reference Signs List

1 CONTROL SYSTEM

2 UNMANNED VEHICLE

3 MANAGEMENT DEVICE

4 COMMUNICATION SYSTEM

6 WIRELESS COMMUNICATION DEVICE

7 LOADER

8 CRUSHER

10 CONTROL DEVICE

11 INPUT AND OUTPUT INTERFACE

12 ARITHMETIC PROCESSING DEVICE

121 TRAVELING CONDITION DATA ACQUISITION UNIT

122 POSITION DATA ACQUISITION UNIT

123 DETECTION DATA ACQUISITION UNIT

124 TRAVEL CONTROL UNIT

13 STORAGE DEVICE

21 VEHICLE BODY

22 DUMP BODY

23 TRAVELING DEVICE

23A DRIVE DEVICE

23B BRAKE DEVICE

23C STEERING DEVICE

27 WHEEL

27F FRONT WHEEL

27R REAR WHEEL

28 WIRELESS COMMUNICATION DEVICE

31 INPUT AND OUTPUT INTERFACE

32 ARITHMETIC PROCESSING DEVICE

321 UNMANNED VEHICLE DATA ACQUISITION UNIT

322 ROAD SURFACE CONDITION DATA ACQUISITION UNIT

323 TRAVELING CONDITION DATA GENERATION UNIT

324 PERMITTED AREA SETTING UNIT

33 STORAGE DEVICE

35 INPUT DEVICE

36 OUTPUT DEVICE

41 POSITION SENSOR

42 STEERING ANGLE SENSOR

43 AZIMUTH ANGLE SENSOR

44 SPEED SENSOR

45 ROAD SURFACE CAMERA

AP PERMITTED AREA

BP ADDITIONAL PERMITTED AREA

CS TRAVEL COURSE

HL TRAVEL PATH

IS INTERSECTION

PA WORK AREA

PI TARGET POINT

SL SLIP AMOUNT

SP STOP POINT

1. An unmanned vehicle control system for setting a permitted area where travelling is permitted for each unmanned vehicle, the unmanned vehicle control system comprising:
an unmanned vehicle data acquisition unit that acquires unmanned vehicle data including position data of the unmanned vehicle;
a road surface condition data acquisition unit that acquires road surface condition data that allows estimation of accuracy of stopping of a travel path on which the unmanned vehicle travels; and
a traveling condition data generation unit that generates data including a permitted area in a travel path of the unmanned vehicle, a stop point in the permitted area, and a target traveling speed for the unmanned vehicle to stop at the stop point on a basis of the unmanned vehicle data acquired by the unmanned vehicle data acquisition unit,
wherein the traveling condition data generation unit sets the permitted area or the stop point on a basis of the road surface condition data of a predetermined area including the stop point acquired by the road surface condition data acquisition unit.

2. The unmanned vehicle control system according to claim 1,
wherein the traveling condition data generation unit extends the permitted area ahead in a traveling direction with respect to the stop point depending on a slip amount estimated in the predetermined area including the stop point.

3. The unmanned vehicle control system according to claim 1,
wherein the traveling condition data generation unit sets the stop point at a position shifted toward a rear end of the permitted area depending on a slip amount estimated in the predetermined area including the stop point.

4. The unmanned vehicle control system according to claim 1,
wherein the road surface condition data includes data related to a moisture content of a road surface.

5. The unmanned vehicle control system according to claim 4,
wherein the road surface condition data includes position data of a spot set by an operator.

6. The unmanned vehicle control system according to claim 4,
wherein the road surface condition data includes sprinkled water data including an amount of sprinkled water sprinkled on a road surface by a sprinkler vehicle.

7. The unmanned vehicle control system according to claim 4,
wherein the road surface condition data includes image data of a road surface captured by a camera that captures an image of a road surface of a travel path.

8. The unmanned vehicle control system according to claim 4,
wherein the road surface condition data includes travel data of another unmanned vehicle.

9. An unmanned vehicle controlled by the unmanned vehicle control system according to claim 1.

10. An unmanned vehicle control method for setting a permitted area where traveling is permitted for each unmanned vehicle, the unmanned vehicle control method comprising:
acquiring unmanned vehicle data including position data of the unmanned vehicle;
acquiring road surface condition data of a travel path on which the unmanned vehicle travels; and
generating data including a permitted area in the travel path of the unmanned vehicle, a stop point in the permitted area, and a target traveling speed for the unmanned vehicle to stop at the stop point on a basis of the unmanned vehicle data that has been acquired,
wherein the permitted area is set on a basis of the road surface condition data of a predetermined area including the stop point.
